(19) United States
(12) Patent Application Publication
(10) Pub. No.: US 2024/0378817 A1
(43) Pub. Date: Nov. 14, 2024

(54) HEAD-DRIVEN, SELF-CAPTURED PHOTOGRAPHY

(71) Applicant: International Business Machines Corporation, Armonk, NY (US)

(72) Inventors: Xiao Feng Ji, Shanghai (CN); Ya Qing Chen, Shanghai (CN); Chuan Le Zheng, SHANGHAI (CN); Liang Ying Xu, Beijing (CN); RUN HUA CHI, Shanghai (CN); Jian Wang, Shanghai (CN)

(21) Appl. No.: 18/314,175

(22) Filed: May 9, 2023

(51) Int. Cl. G06T 19/00; G06F 3/01; G06V 40/16; G06V 40/18

(52) U.S. Cl. CPC G06T 19/006; G06F 3/012; G06V 40/176; G06V 40/18

(57) ABSTRACT

According to one embodiment, a method, computer system, and computer program product for head-driven, self-captured photography is provided. The embodiment may include detecting a trigger event performed by a user while the user is interacting with a virtual environment. The embodiment may also include displaying a virtual camera within the virtual environment. The embodiment may further include modifying a location, a distance, and an orientation of the virtual camera in relation to the user based on a plurality of facial movement trigger events by the user. The embodiment may also include capturing one or more images using the virtual camera at the location, the distance, and the orientation based on a facial movement trigger event within the plurality of facial movement trigger events.

### BACKGROUND

The present invention relates generally to the field of computing, and more particularly to augmented reality/virtual reality (AR/VR).

Virtual reality relates to technology that generates an immersive, computer-rendered environment in which a user can engage with and experience through various sensory feedbacks. Similarly, augmented reality relates to technology that modifies a direct or indirect user view of a real-world environment with computer-generated elements using various inputs, such as sound data, image data, or location data. Various technologies may be implemented when utilizing AR/VR, such as eyeglasses, head-mounted displays, head-up displays, contact lenses, virtual reality displays, and handheld displays. Augmented reality may have numerous applications within society including uses in literature, architecture, visual art, education, emergency management, video gaming, medicine, military, navigation, tourism, language translation, and music production.

The metaverse relates to a computer-generated virtual space that allows individuals to interact with each other through digital representations of themselves called avatars. Users can engage in various activities inside metaverse through AR/VR technologies, such as, but not limited to, gaming, life simulation, education, and socialization. First popularized in pop culture media, the metaverse is quickly becoming a reality as many organizations aim to increase its presence in everyday life.

### SUMMARY

According to one embodiment, a method, computer system, and computer program product for head-driven, self-captured photography is provided. The embodiment may include detecting a trigger event performed by a user while the user is interacting with a virtual environment. The embodiment may also include displaying a virtual camera within the virtual environment. The embodiment may further include modifying a location, a distance, and an orientation of the virtual camera in relation to the user based on a plurality of facial movement trigger events by the user. The embodiment may also include capturing one or more images using the virtual camera at the location, the distance, and the orientation based on a facial movement trigger event within the plurality of facial movement trigger events.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for head-driven, self-captured photography process according to at least one embodiment.

FIGS. 3A-3C are exemplary block diagrams of a location setting mode according to at least one embodiment.

FIGS. 4A-4C are exemplary block diagrams of a distance setting mode according to at least one embodiment.

FIGS. 5A-5B are exemplary block diagrams of an orientation setting mode according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to augmented reality/virtual reality (AR/VR). The following described exemplary embodiments provide a system, method, and program product to, among other things, head-driven, self-captured photography within an AR/VR environment. Therefore, the present embodiment has the capacity to improve the technical field of AR/VR by adding dynamic and diverse user interactions with AR/VR technologies that improve the user experience and usability.

As previously described, virtual reality relates to technology that generates an immersive, computer-rendered environment in which a user can engage with and experience through various sensory feedbacks. Similarly, augmented reality relates to technology that modifies a direct or indirect user view of a real-world environment with computer-generated elements using various inputs, such as sound data, image data, or location data. Various technologies may be implemented when utilizing AR/VR, such as eyeglasses, head-mounted displays, head-up displays, contact lenses, virtual reality displays, and handheld displays. Augmented reality may have numerous applications within society including uses in literature, architecture, visual art, education, emergency management, video gaming, medicine, military, navigation, tourism, language translation, and music production.

The metaverse relates to a computer-generated virtual space that allows individuals to interact with each other through digital representations of themselves called avatars. Users can engage in various activities inside metaverse through AR/VR technologies, such as, but not limited to, gaming, life simulation, education, and socialization. First popularized in pop culture media, the metaverse is quickly becoming a reality as many organizations aim to increase its presence in everyday life.

Many people enjoy taking photographs throughout their daily lives. Modern technology has enabled photographs and videos to be taken more easily and more cost effectively than ever before in human history. Currently, one of the most popular types of photographs or videos taken are self-captured (i.e., selfies). Self-captured photographs or videos appear popular due to their convenience over text to record moments, ability to allow individuals to express their current mood and share important expressions, services toward social interaction and self-expression that forge bonds between individuals, and platform as a vehicle for self-presentation as a positive part of an individual's identity discovery.

Meanwhile, AR/VR technologies, such as the metaverse, continue to grow as various virtual scenes, activities, and objects are introduced. As these AR/VR technologies increase in popularity, an expected increase in the desire to capture photographs and videos will naturally increase for the reasons stated above. However, taking a self-captured photograph in a real-world environment requires one or both hands depending on the photographic capture device being used and may also require a bit of user skill. When an individual is interacting with an AR/VR environment, both of their hands may be indisposed for capturing a photograph or video since a user may need to hold one or more controllers to navigate and interact with the AR/VR hardware units. As such, it may be advantageous to, among other things, provide head-driven controls that allow a user to engage in photographic capture while interacting in an AR/VR environment.

According to at least one embodiment, a head-driven, self-captured photograph program may monitor user facial expressions during a user's interaction with an AR/VR hardware device. The head-driven, self-captured photograph program may recognize trigger events based on user facial actions that instruct the head-driven, self-captured photograph program to enter a photographic capture mode. Within the photographic capture mode, the head-driven, self-captured photograph program may allow the user to separately establish a virtual camera location within the AR/VR landscape, distance in relation to the user or user avatar, and angled orientation in relation to the user or user avatar. Upon establishing one or more of these settings, the head-driven, self-captured photograph program may monitor the user facial expressions for an instructive trigger to capture a photograph or video. The head-driven, self-captured photograph program may also allow for readjustment of the location, distance, and orientation settings or a termination of the photographic capture mode at any time based on one or more other user facial expression trigger.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

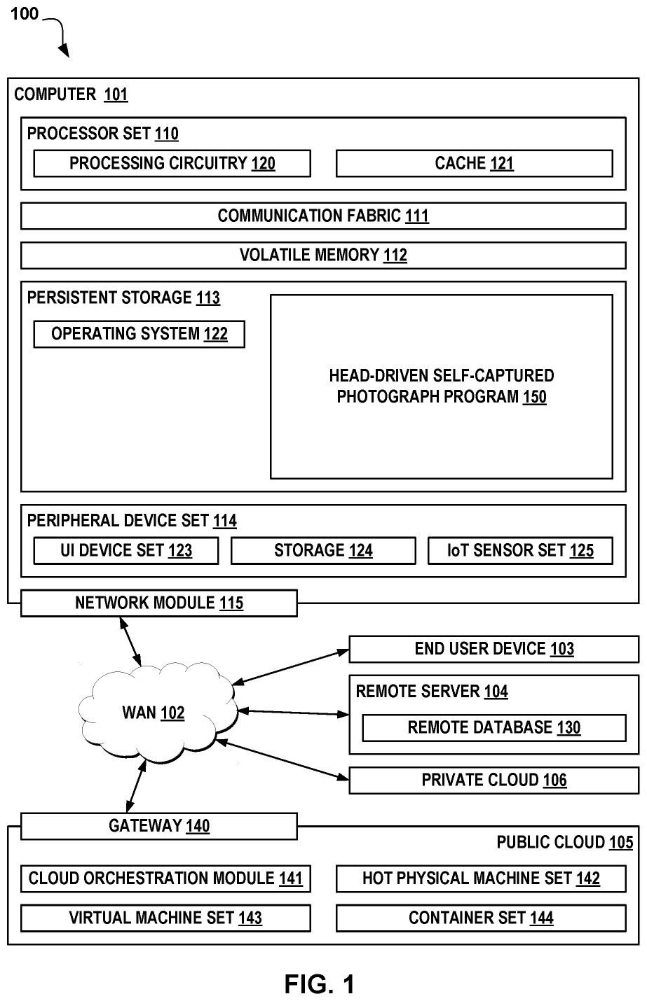

Referring now to FIG. 1, computing environment 100 contains an example of an environment for the execution of at least some of the computer code involved in performing the inventive methods, such as head-driven, self-captured photograph program 150. In addition to head-driven, self-captured photograph program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and head-driven, self-captured photograph program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in head-driven, self-captured photograph program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in head-driven, self-captured photograph program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to at least one embodiment, the head-driven, self-captured photograph program 150 may be capable of capturing user facial actions while the user is interacting with AR/VR hardware, such as an AR/VR headset, using one or more sensors embedded in or otherwise communicatively coupled to the AR/VR hardware. The head-driven, self-captured photograph program 150 may monitor the user interactions for trigger events that may be preconfigured to initiate a photographic capture mode and various setting modes within the photographic capture mode, such as a location setting mode, a distance setting mode, and an orientation setting mode. The preconfigured trigger events may include, but are not limited to, various facial actions or movements (e.g., a pattern of eye blinks, forehead movements, or mouth movements). Furthermore, the head-driven, self-captured photograph program 150 may capture a photograph of the user, or a user avatar, and the surrounding real-world or virtual space depending on the AR/VR environment, upon detection of another user-performed trigger event.

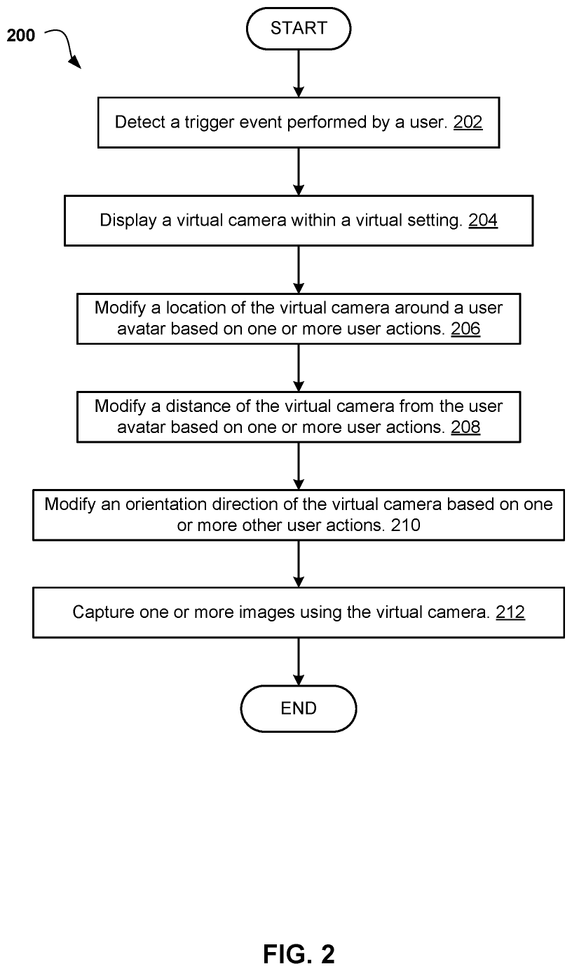

Additionally, prior to performance of a method for head-driven, self-captured photography, the head-driven, self-captured photograph program 150 may perform an opt-in procedure prior to monitoring user interactions with the AR/VR hardware and monitoring for user interactions as trigger events. The opt-in procedure may include a notification of the data the head-driven, self-captured photograph program 150 may capture and the purpose for which that data may be utilized by the head-driven, self-captured photograph program 150 during the performance of the method. Furthermore, notwithstanding depiction in computer 101, the head-driven, self-captured photograph program 150 may be stored in and/or executed by, individually or in any combination, end user device 103, remote server 104, public cloud 105, and private cloud 106. The head-driven, self-captured photograph method is explained in more detail below with respect to FIGS. 2-5C.

Referring now to FIG. 2, an operational flowchart illustrating a head-driven, self-captured photograph process 200 is depicted according to at least one embodiment. At 202, the head-driven, self-captured photograph program 150 detects a trigger event performed by a user. As previously described, the head-driven, self-captured photograph program 150 may monitor user facial actions and/or movements while the user is engaging with an AR/VR environment for the occurrence of a preconfigured trigger event signaling a user desire to enter a photographic capture mode. For example, the head-driven, self-captured photograph program 150 may be preconfigured to enter into a photographic capture mode when a user blinks their left eye once followed by their right eye once within a preconfigured period of time.

Then, at 204, the head-driven, self-captured photograph program 150 displays a virtual camera within a virtual setting. Once the head-driven, self-captured photograph program 150 detects the occurrence of the photographic capture mode trigger event, the head-driven, self-captured photograph program 150 may display a virtual camera visible to the user, but possibly invisible to other users, in the AR/VR environment. In at least one embodiment, if the user wishes for the virtual camera to be visible to other users in the AR/VR environment, the user may modify one or more visibility settings available to the head-driven, self-captured photograph program 150. The virtual camera may appear as a preconfigured default location, distance, and orientation in relation to the user. For example, the camera may initially appear five feet away from the user with the lens facing directly toward the geographic center of the user's, or user avatar's, head. In at least one embodiment, the head-driven, self-captured photograph program 150 may display the virtual camera with a preconfigured level of transparency or color modification, such as tinting the virtual camera a shade of a non-standard color, to indicate that the virtual camera is in a settings mode and not prepared for immediate photographic capture until the settings mode (e.g., location, distance, and orientation) is completed and confirmed by the user. Additionally, the head-driven, self-captured photograph program 150 may display the virtual camera, while in the settings mode, with a dashed or dotted line emanating from the center of the camera lens in a straight line directed toward the location of photographic capture (e.g., a camera movement track line) in order to assist the user during the settings mode.

In at least one embodiment, the head-driven, self-captured photograph program 150 may monitor the user for one or more additional trigger events that instruct the head-driven, self-captured photograph program 150 to move the default location of the virtual camera. For example, the head-driven, self-captured photograph program 150 may detect user facial movements of the user blinking their right eye once followed by their left eye once in close succession to trigger the head-driven, self-captured photograph program 150 to move the virtual camera from facing the user's, or user avatar's, face to behind the user's, or user avatar's, head to allow the virtual camera to take a picture of the environment toward which the user is facing.

While in the settings mode, and any stage of the settings mode, the head-driven, self-captured photograph program 150 may present a live image that is continuously captured by the virtual camera where the user or user avatar is shown and presented on the AR/VR hardware display screen to the user. For example, the head-driven, self-captured photograph program 150 may present a picture-in-picture window on a subset of the AR/VR hardware display screen that displays the view of the virtual camera while the user is interacting during the settings mode.

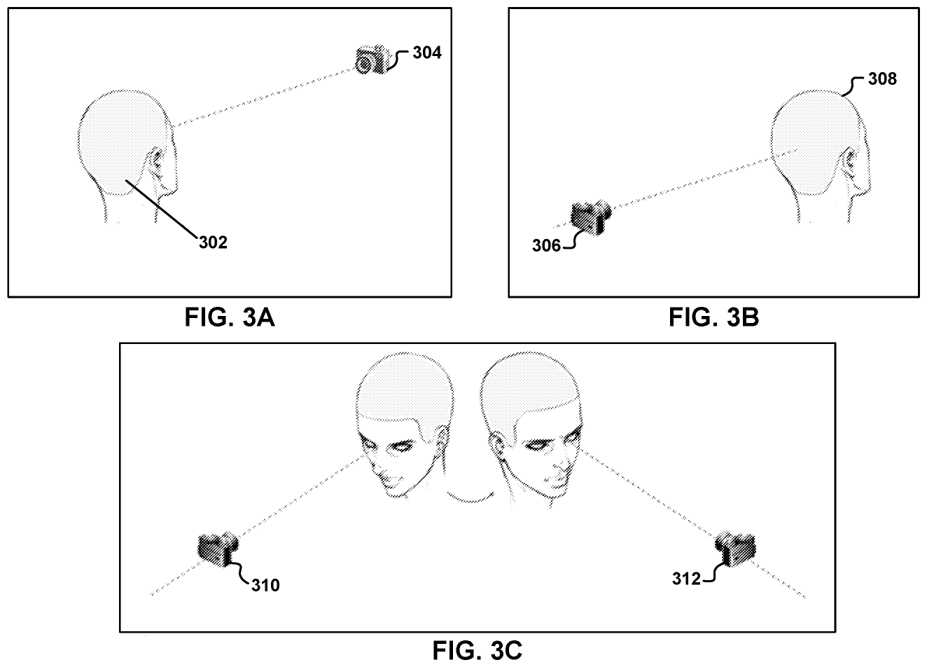

Next, at 206, the head-driven, self-captured photograph program 150 modifies a location of the virtual camera around a user avatar based on one or more user actions. Upon display of the virtual camera, the head-driven, self-captured photograph program 150 may enter into a location setting mode. The location setting mode may be a subset of the broader settings mode prior to allowing a user to engage in photographic capture within the AR/VR environment. In the location setting mode, the head-driven, self-captured photograph program 150 may allow the user to place the camera at a fixed location within the AR/VR environment. The head-driven, self-captured photograph program 150 may track the movement of the virtual camera around the AR/VR environment based on the user's head rotation as captured by one or more sensors within the AR/VR hardware (e.g., one or more gyroscopes and/or accelerometers within an AR/VR headset). Thus, the head-driven, self-captured photograph program 150 may allow the user to change both the direction of the virtual camera movement track and the location of the virtual camera by changing the orientation of the user's face. The location setting mode is described in further detail in FIGS. 3A-3C. Once the virtual camera is placed within a user-acceptable location, the head-driven, self-captured photograph program 150 may capture a user configuration expression or gesture (e.g., three eye blinks) as a trigger event to proceed to the next step of the settings mode.

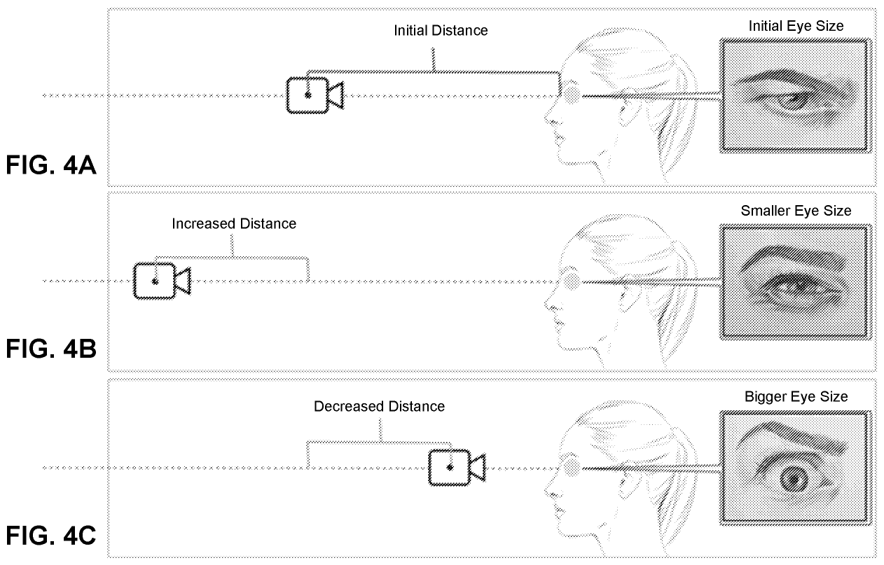

Then, at 208, the head-driven, self-captured photograph program 150 modifies a distance of the virtual camera from the user avatar based on one or more user actions. Upon receiving confirmation from the user on the desired location within the AR/VR environment at which to place the virtual camera (e.g., the desired location of the camera movement track is confirmed by the user), the head-driven, self-captured photograph program 150 may switch to a distance setting mode which may establish a distance from the user at which to place the virtual camera. The head-driven, self-captured photograph program 150 may switch from the location setting mode to the distance setting mode based on a preconfigured user confirmation trigger event, such as the user blinking twice. When the head-driven, self-captured photograph program 150 initiates the distance setting mode, the head-driven, self-captured photograph program 150 may place the virtual camera at a preconfigured distance from the user. The head-driven, self-captured photograph program 150 may allow the user to modify this distance through one or more trigger event actions. For example, the head-driven, self-captured photograph program 150 may modulate the distance of the virtual camera based on the openness of the user's eyes using a baseline eye size as determined by an average openness of the user's eyes over a given period of time or by the openness of the user's eyes at the time the head-driven, self-captured photograph program 150 enters the distance setting mode. The distance setting mode modifying the distance of the virtual camera from the user based on user eye openness is discussed further in FIGS. 4A-4C.

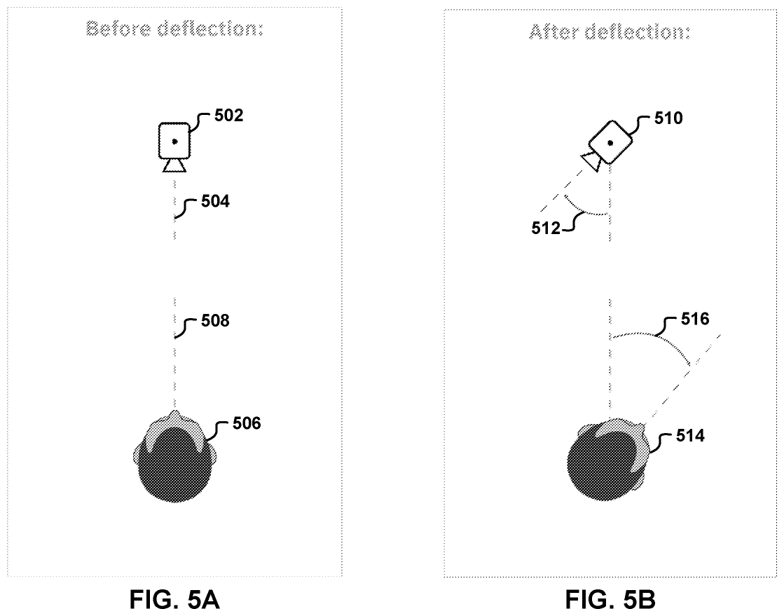

Next, at 210, the head-driven, self-captured photograph program 150 modifies an orientation direction of the virtual camera based on one or more other user actions. Once the user confirms the desired distance of the virtual camera in the AR/VR environment at which to place the virtual camera, the head-driven, self-captured photograph program 150 may initiate an orientation setting mode which may establish an orientation of the virtual camera at the desired location and distance in relation to the user. The head-driven, self-captured photograph program 150 may switch from the distance setting mode to the orientation setting mode based on the preconfigured user confirmation trigger event. While in the orientation setting mode, the head-driven, self-captured photograph program 150 may rotate the virtual camera around a fixed point (e.g., the geometric center of the virtual camera) in the AR/VR environment. The head-driven, self-captured photograph program 150 may base the magnitude and direction of the rotation on the user's head movement while wearing the AR/VR hardware. The orientation setting mode is discussed further with respect to FIGS. 5A and 5B.

Then, at 212, the head-driven, self-captured photograph program 150 captures one or more images using the virtual camera. Similar to steps 208 and 210 with respect to the location setting mode and the distance setting mode, the head-driven, self-captured photograph program 150 may initiate a photographic capture mode once the user confirms the desired orientation of the virtual camera in the AR/VR environment. With the location, distance, and orientation of the virtual camera in the AR/VR environment confirmed, the head-driven, self-captured photograph program 150 may initiate a photographic capture mode to allow the user to begin capturing images of the desired entities within the AR/VR environment upon the detection of a user-initiated trigger event. The user-initiated trigger event for image capture may be any preconfigured user movement or interaction with the AR/VR hardware or within the AR/VR environment. For example, in one embodiment, the head-driven, self-captured photograph program 150 may preconfigure a user interaction with a specific button of an AR/VR hardware controller to serve as the trigger event for image capture. In another embodiment, the head-driven, self-captured photograph program 150 may be preconfigured to detect a specific user facial action (e.g., series of eye blinks or winks) as the user-initiated trigger event for image capture.

Upon capturing the desired number of images at the desired location, distance, and orientation, the head-driven, self-captured photograph program 150 may monitor for user interactions with the AR/VR hardware or AR/VR environment indicative of the user desiring to disengage a photographic capture mode of the head-driven, self-captured photograph program 150 or modify the previously selected location, distance, and orientation of the virtual camera. For example, if the user is finished with capturing images, the head-driven, self-captured photograph program 150 may be preconfigured to detect a left eye blink followed by a right eye blink in a preconfigured period of time as an event trigger to exit image capture mode and return to a previous operation of the AR/VR device. Similarly, the head-driven, self-captured photograph program 150 may be preconfigured to detect three successive eye blinks in a preconfigured period of time as an event trigger to modify either the location, distance, or orientation of the virtual camera. Therefore, the head-driven, self-captured photograph program 150 may return to steps 206-210 to modify the location, distance, and orientation settings.

In one or more embodiments, the head-driven, self-captured photograph program 150 may initiate a preconfigured countdown timer upon detecting the user-initiated image capture trigger event. For example, when the head-driven, self-captured photograph program 150 detects an image capture trigger event of a user blinking twice quickly in succession, the head-driven, self-captured photograph program 150 may begin a countdown timer that displays each integer of the countdown on a user device display screen of the AR/VR hardware device.

Referring now to FIGS. 3A-3C, exemplary block diagrams of a location setting mode are depicted according to at least one embodiment. In FIG. 3A, the head-driven, self-captured photograph program 150 may initially display virtual camera 304 directly in front of the point of view of user 302, or user avatar, within the AR/VR environment. While in the location setting mode, the lens of the virtual camera may continually point toward the user, or user avatar, and initially focus on the geometric center of the user or user avatar's head. In FIG. 3B, if the user 308 performs a preconfigured facial movement (e.g., left eye blink), the head-driven, self-captured photograph program 150 may remove the virtual camera from being displayed directly in front of the user or user avatar and display the virtual camera 306 directly behind the user 308 or user avatar.

In FIG. 3C, the head-driven, self-captured photograph program 150 may track the camera movement following the rotation of the user's head movement throughout the location setting mode. The head-driven, self-captured photograph program 150 may track the geometric center of the virtual camera toward the user. Therefore, the head-driven, self-captured photograph program 150 may change both the direction of the camera movement track and the location of the virtual camera by changing the orientation of the user's face anywhere in the sphere surrounding the user. For example, FIG. 3C depicts virtual camera movements from a first position 310 to a second position 312 as the user rotates their head direction within the AR/VR environment.

Referring now to FIGS. 4A-4C, exemplary block diagrams of a distance setting mode are depicted according to at least one embodiment. In FIG. 4A, the initial distance of the virtual camera from the user is depicted along with the initial eye size of the user. The initial eye size may be preconfigured as the initial eye size as measured when the head-driven, self-captured photograph program 150 enters into the distance setting mode or the average user eye size measured over a preconfigured period of time. Furthermore, the head-driven, self-captured photograph program 150 may keep the virtual camera in a current position in relation to the user when the head-driven, self-captured photograph program 150 measures the user eye size to be within a preconfigured measurement deviation from the initial eye size. In FIG. 4B, the head-driven, self-captured photograph program 150 may move the camera further away from the user when the user eye size is smaller than the initial eye size. The increased distance along the camera movement track may have a linear (or, in another embodiment, exponential) relationship with the time duration of the user's smaller eye size. Conversely, in FIG. 4C, the head-driven, self-captured photograph program 150 may move the camera closer to the user when the user eye size is larger than the initial eye size. The decreased distance along the camera movement track may have a linear (or, in another embodiment, exponential) relationship with the time duration of the user's eyes opening wider. In one or more embodiments, the head-driven, self-captured photograph program 150 may inverse these trigger controls thereby allowing an increase in the distance of the virtual camera from the user when the user's eye size is larger than the baseline eye size and a decrease in the distance of the virtual camera from the user when the user's eye size is smaller than the baseline eye size.

In another embodiment, the head-driven, self-captured photograph program 150 may utilize the size of the eye region represented as the size of an area enclosed by predetermined eye landmarks (e.g., cornea, iris, etc.) captured based on the viewing angle of the virtual camera and projected to a plane where the viewing window of the virtual camera is located. In yet another embodiment, the head-driven, self-captured photograph program 150 may utilize the size of the eye region represented as the length of a straight line connected by two predetermined three-dimensional eye key points of one eye. In either situation when the camera is moving toward the user or away from the user based on the user's eye size being smaller or larger, respectively, the head-driven, self-captured photograph program 150 may focus the virtual camera automatically at the center of the pixel area depicting the user or the user avatar in a two-dimensional image captured by the virtual camera, which may be identified through an instance segmentation technique.

Referring now to FIGS. 5A-5B, exemplary block diagrams of an orientation setting mode are depicted according to at least one embodiment. In FIG. 5A, upon initiating the orientation setting mode, the virtual camera 502 may be affixed to a single position in the AR/VR environment, based on the location setting mode and the distance setting mode, with a direction 504 facing the user or the user avatar 506, which has a direction 508 facing the virtual camera 502. In FIG. 5B, the virtual camera 510 may track the user's head movement to establish a proper deflection angle of orientation 516. The head-driven, self-captured photograph program 150 may establish the deflection angle 516 as the angular distance from the initial, or original, direction the user or user avatar 514 was facing the virtual camera 510 to the direction the user or user avatar 514 is currently facing. In comparison, the head-driven, self-captured photograph program 150 may replicate the angular distance of the virtual camera 510 and establish the deflection angle 512 of the virtual camera 510 to be a parallel angle offset in the same direction (in relation to the user's movement) from the virtual camera's perspective. In another embodiment, the head-driven, self-captured photograph program 150 may establish the deflection angle 516 as an anti-parallel angle offset in the same direction in relation to the user's movement. For example, if the user 514 moves their head to the user's right at an angular distance of 45 degrees, the virtual camera 510 may move its orientation to the virtual camera's left at an angular distance of 45 degrees so as to appear to the user 514 that the virtual camera 510 is tracking the user's rightward head rotation.

It may be appreciated that FIGS. 2-5B provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
detecting a trigger event performed by a user while the user is interacting with a virtual environment;
displaying a virtual camera within the virtual environment;
modifying a location, a distance, and an orientation of the virtual camera in relation to the user based on a plurality of facial movement trigger events by the user; and
capturing one or more images using the virtual camera at the location, the distance, and the orientation based on a facial movement trigger event within the plurality of facial movement trigger events.

2. The method of claim 1, wherein the virtual camera is initially displayed at a preconfigured location within the virtual environment, displayed at a preconfigured distance from the user or a user avatar, and oriented toward a geometric center of a face of the user or the user avatar.

3. The method of claim 1, wherein the location is determined based on a tracking of user head rotations in the virtual environment and a confirmation by the user through a preconfigured series of facial actions.

4. The method of claim 1, wherein the distance is determined based on a tracking of a user eye size and a confirmation by the user through a preconfigured series of facial actions.

5. The method of claim 4, wherein detecting the user eye size is smaller than a baseline user eye size triggers an increase in the distance of the virtual camera from the user or the user avatar, and wherein detecting the user eye size is larger than the baseline user eye size triggers a decrease in the distance of the virtual camera from the user or the user avatar, and wherein the distance is further determined by a time duration for which the user eye size is not equal to the baseline user eye size.

6. The method of claim 1, wherein the orientation is determined based on a tracking of a user head rotation in the virtual environment and a confirmation by the user through a preconfigured series of facial actions.

7. The method of claim 6, wherein the orientation is further determined by replicating an angular distance and a direction of the user head rotation, as measured from an original orientation of a user head to a current orientation of the user head after the user head rotation, at the location of the virtual camera.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
detecting a trigger event performed by a user while the user is interacting with a virtual environment;
displaying a virtual camera within the virtual environment;
modifying a location, a distance, and an orientation of the virtual camera in relation to the user based on a plurality of facial movement trigger events by the user; and
capturing one or more images using the virtual camera at the location, the distance, and the orientation based on a facial movement trigger event within the plurality of facial movement trigger events.

9. The computer system of claim 8, wherein the virtual camera is initially displayed at a preconfigured location within the virtual environment, displayed at a preconfigured distance from the user or a user avatar, and oriented toward a geometric center of a face of the user or the user avatar.

10. The computer system of claim 8, wherein the location is determined based on a tracking of user head rotations in the virtual environment and a confirmation by the user through a preconfigured series of facial actions.

11. The computer system of claim 8, wherein the distance is determined based on a tracking of a user eye size and a confirmation by the user through a preconfigured series of facial actions.

12. The computer system of claim 11, wherein detecting the user eye size is smaller than a baseline user eye size triggers an increase in the distance of the virtual camera from the user or the user avatar, and wherein detecting the user eye size is larger than the baseline user eye size triggers a decrease in the distance of the virtual camera from the user or the user avatar, and wherein the distance is further determined by a time duration for which the user eye size is not equal to the baseline user eye size.

13. The computer system of claim 8, wherein the orientation is determined based on a tracking of a user head rotation in the virtual environment and a confirmation by the user through a preconfigured series of facial actions.

14. The computer system of claim 13, wherein the orientation is further determined by replicating an angular distance and a direction of the user head rotation, as measured from an original orientation of a user head to a current orientation of the user head after the user head rotation, at the location of the virtual camera.

15. A computer program product, the computer program product comprising:
one or more computer-readable tangible storage medium and program instructions stored on at least one of the one or more tangible storage medium, the program instructions executable by a processor capable of performing a method, the method comprising:
detecting a trigger event performed by a user while the user is interacting with a virtual environment;
displaying a virtual camera within the virtual environment;
modifying a location, a distance, and an orientation of the virtual camera in relation to the user based on a plurality of facial movement trigger events by the user; and
capturing one or more images using the virtual camera at the location, the distance, and the orientation based on a facial movement trigger event within the plurality of facial movement trigger events.

16. The computer program product of claim 15, wherein the virtual camera is initially displayed at a preconfigured location within the virtual environment, displayed at a preconfigured distance from the user or a user avatar, and oriented toward a geometric center of a face of the user or the user avatar.

17. The computer program product of claim 15, wherein the location is determined based on a tracking of user head rotations in the virtual environment and a confirmation by the user through a preconfigured series of facial actions.

18. The computer program product of claim 15, wherein the distance is determined based on a tracking of a user eye size and a confirmation by the user through a preconfigured series of facial actions.

19. The computer program product of claim 18, wherein detecting the user eye size is smaller than a baseline user eye size triggers an increase in the distance of the virtual camera from the user or the user avatar, and wherein detecting the user eye size is larger than the baseline user eye size triggers a decrease in the distance of the virtual camera from the user or the user avatar, and wherein the distance is further determined by a time duration for which the user eye size is not equal to the baseline user eye size.

20. The computer program product of claim 15, wherein the orientation is determined based on a tracking of a user head rotation in the virtual environment and a confirmation by the user through a preconfigured series of facial actions.
